(19) United States
(12) Patent Application Publication
(10) Pub. No.: US 2015/0199877 A1
(43) Pub. Date: Jul. 16, 2015

(54) NUDGE GAME CENTRAL ACCOUNTING SYSTEM

(71) Applicants: Lonnie G. Pope, Gainesville, GA (US); Christopher S. Fellows, Dacula, GA (US); Michael Ray Moore, Morris, AL (US)

(72) Inventors: Lonnie G. Pope, Gainesville, GA (US); Christopher S. Fellows, Dacula, GA (US); Michael Ray Moore, Morris, AL (US)

(21) Appl. No.: 14/669,711

(22) Filed: Mar. 26, 2015

Related U.S. Application Data
(63) Continuation-in-part of application No. 13/913,638, filed on Jun. 10, 2013.
(60) Provisional application No. 61/832,472, filed on Jun. 7, 2013.

(51) Int. Cl. G07F 17/32

(52) U.S. Cl. CPC G07F 17/3244

(57) ABSTRACT

Systems and methods for providing a nudge game are disclosed. An example method may include collecting an amount of funds using a cash station, wherein the cash station is operatively associated with a central server, the central server including a nudge game application and a central accounting system. The method may further include reporting the amount of funds to the central accounting system, depositing the amount of funds in a user account by the central accounting system, presenting the nudge game application using a nudge game station, allowing play of a nudge game of the nudge game application if the user account contains a requisite amount of funds, producing a resultant amount of funds upon completion of an iteration of the nudge game, and depositing the resultant amount of funds in the user account.

### TECHNICAL FIELD OF THE DISCLOSURE

The present disclosure relates to accounting systems and, more specifically, to accounting systems for gaming systems.

### BACKGROUND OF THE DISCLOSURE

In a traditional slot machine game, the player may initiate the game (e.g., by pulling a lever, pushing a button, etc.) and a plurality of reels will move, displaying a “tumbling” or “rolling” of symbols. Eventually, the reels will stop and the player will examine the reels to see if a winning combination of symbols is present. For example, in some traditional slot machine games, a horizontal row of matching symbols will signify a “winning” game. Such a winning line of symbols may be referred to as a “payline,” as the line of symbols results in a payment of cash, a receipt for cash, tokens, and/or a credit to an account associated with the player. If the game does not result in a payline, the game is over and player has the option to play again.

A nudge game is a modification of traditional slot machine games which provides the player with a chance to win the game even if the first rolling of the reels does not produced a winning payline. In some nudge games, if there is no winning payline, the player may prod or manipulate one reel up or down one place or notch (a “nudge” action) to see if the player can create a winning combination. If the “nudge” action produces a winning payline, then a payment to the player may be made, similarly to the payments made in traditional slot machine games.

However, as nudge games have evolved, the nudge family of games has grown to encompass games that do not allow the player to “nudge” as described above, but rather require the player to make an act of recognizing (or not recognizing) a winning payline. In certain jurisdictions, this simple act of recognition constitutes an act of skill, thereby converting the game from a game of chance (e.g., the traditional slot machine) to a game of skill. In some jurisdictions, such games of skill, like a nudge game, are legal while games of chance are not legal.

In such jurisdictions, nudge games may exist as independent games or game stations wherein the player deposits his/her money, plays the game, and receives a payout in the event of a winning payline. However, such independent nudge games create a burden on the player of cashing out and/or depositing funds into each machine played. Therefore, a need exists for systems and methods to allow a player to freely move from one nudge game to another without the burden of cashing out and depositing upon each game play.

### SUMMARY OF THE DISCLOSURE

In accordance with one aspect of the disclosure a system for providing a nudge game is disclosed. The system may include a central server, the central server including a nudge game application and a central accounting system. The system may further include a cash station operatively associated with the central server to collect an amount of funds, wherein the cash station reports the amount of funds to the central accounting system and the central accounting system deposits the funds in a user account. The system may further include a nudge game station operatively associated with the central server to present the nudge game application, wherein a nudge game of the nudge game application is available for play if the user account contains a requisite amount of funds and wherein the nudge game application produces a resultant amount of funds upon completion of an iteration of the nudge game, the resultant amount of funds being deposited in to the user account.

In a refinement, the user account may be associated with an account card to reference the user account.

In a refinement, the system may further include a plurality of nudge game stations, each member of the plurality of nudge game stations operatively associated with the central server to present the nudge game application.

In a refinement, the central server and the game station may be connected by wired means.

In a refinement, the central server and the game station may be connected by wireless means.

In a refinement, the nudge game station may be a media presentation device at a fixed location.

In a refinement, the nudge game station may be a portable media presentation device.

In accordance with another aspect of the disclosure, a method for providing a nudge game is disclosed. The method may include collecting an amount of funds using a cash station, wherein the cash station is operatively associated with a central server, the central server including a nudge game application and a central accounting system. The method may further include reporting the amount of funds to the central accounting system, depositing the amount of funds in a user account by the central accounting system, presenting the nudge game application using a nudge game station, allowing play of a nudge game of the nudge game application if the user account contains a requisite amount of funds, producing a resultant amount of funds upon completion of an iteration of the nudge game, and depositing the resultant amount of funds in the user account.

In a refinement, the method may further include providing a login at the nudge game station.

In a refinement, the method may further include providing access to a user account using an account card, the account card associated with the user account.

In a refinement, the method may further include providing means to select a wager amount for the nudge game, wherein the wager amount is greater than or equal to the requisite amount of funds.

In a further refinement, the method may further include deducting the wager amount from the user account upon execution of the nudge game.

In a refinement, the method may further include presenting an error message at the nudge game station if the user account does not contain the requisite amount of funds.

In accordance with another aspect of the disclosure, a nontransitory computer readable medium having thereon instructions for performing a method for providing a nudge game is disclosed. The instructions may include instructions for collecting an amount of funds using a cash station, wherein the cash station is operatively associated with a central server, the central server including a nudge game application and a central accounting system. The instructions may further include instructions for reporting the amount of funds to the central accounting system, instructions for depositing the amount of funds in a user account by the central accounting system, instructions for presenting the nudge game application using a nudge game station, instructions for allowing play of a nudge game of the nudge game application if the user account contains a requisite amount of funds, instructions for producing a resultant amount of funds upon completion of an iteration of the nudge game, and instructions for depositing the resultant amount of funds in the user account.

In a refinement, the instructions may further include instructions for providing a login at the nudge game station.

In a refinement, the instructions may further include instructions for providing access to a user account using an account card, the account card associated with the user account.

In a refinement, the instructions may further include instructions for providing means to select a wager amount for the nudge game, wherein the wager amount is greater than or equal to the requisite amount of funds.

In a further refinement, the instructions may further include instructions for deducting the wager amount from the user account upon execution of the nudge game.

In a refinement, the instructions may further include instructions for presenting an error message at the nudge game station if the user account does not contain the requisite amount of funds.

### BRIEF DESCRIPTION OF THE DRAWINGS

FIG. 1 is a schematic diagram of a system for providing a nudge game in accordance with an embodiment of the invention;

FIG. 2 is a flowchart for a funds deposit process associated with the system for providing a nudge game of FIG. 1 in accordance with an embodiment of the invention.

FIG. 3 is a flowchart for a login process associated with the system for providing a nudge game of FIG. 1 in accordance with an embodiment of the invention.

FIG. 4 is a flowchart for a wager process associated with the system for providing a nudge game of FIG. 1 in accordance with an embodiment of the invention.

FIG. 5 is a flowchart for a nudge game associated with the system for providing a nudge game of FIG. 1 in accordance with an embodiment of the invention.

FIG. 6 is an example display state for the nudge game of FIG. 5 in accordance with an embodiment of the invention.

FIG. 7 is an example display state for the nudge game of FIG. 5 in accordance with an embodiment of the invention.

FIG. 8 is a flowchart for a continue operation associated with the system for providing a nudge game of FIG. 1 in accordance with an embodiment of the invention.

FIG. 9 is a flowchart for a method for providing a nudge game in accordance with an embodiment of the invention.

FIG. 10 is a block diagram of an example processing system that may execute machine readable instructions of the invention.

FIG. 11 is a schematic network diagram showing a network configuration in accordance with an embodiment of the invention.

FIG. 12 is a schematic network diagram showing an alternative network configuration in accordance with an embodiment of the invention.

FIG. 13 is a schematic network diagram showing a further alternative network configuration in accordance with an embodiment of the invention.

FIG. 14 is a schematic network diagram showing yet another network configuration in accordance with an embodiment of the invention.

FIG. 15 is a schematic network diagram showing another network configuration in accordance with an embodiment of the invention.

It should be understood that the drawings are not necessarily to scale and that the disclosed embodiments are sometimes illustrated schematically. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE DISCLOSURE

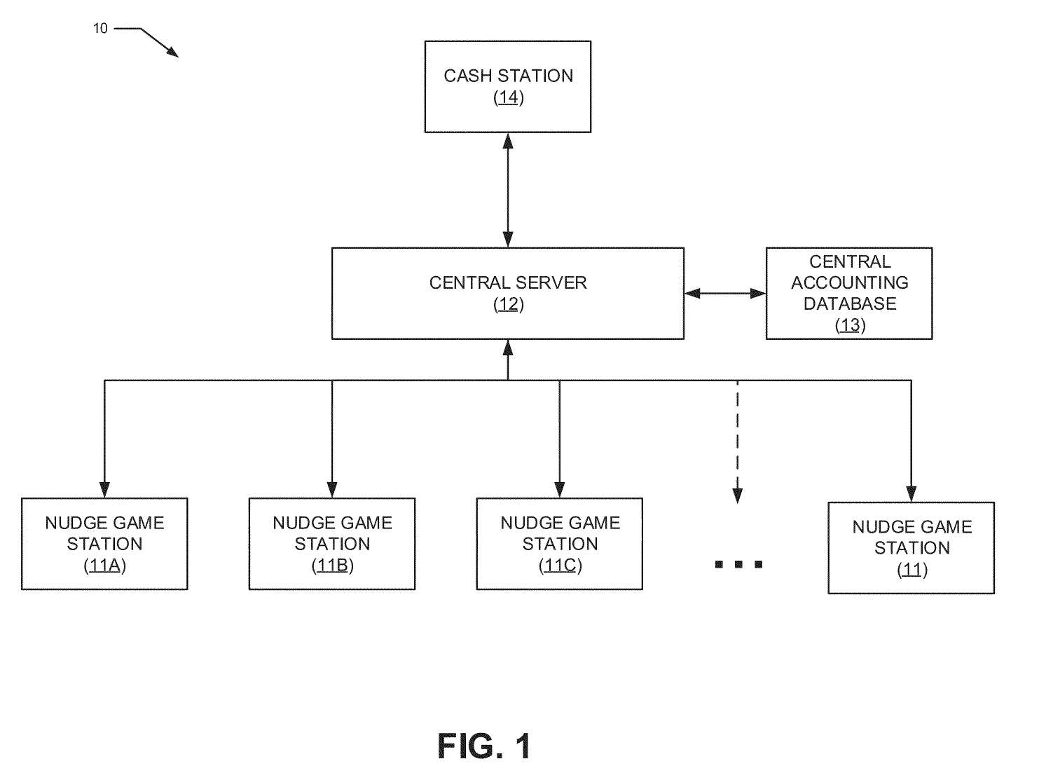

Turning now to the drawings and with specific reference to FIG. 1, a system 10 for providing a nudge game is shown. The system 10 includes one or more nudge game stations 11 for presenting a nudge game to a user. To present the nudge game to the user, the nudge game stations 11 receive instructions from a central server 12. The central server 12 provides the nudge game stations with a nudge game application from which a user may play the nudge game. Information processed by the central server 12 may be stored on a central accounting database 13. The information stored on the central accounting database 13 may include user account information and/or user accounting balances regarding funds input to the system 10 via a cash station 14.

In order to play the nudge game, a user must have a requisite amount of funds deposited in to a user account. The user may deposit funds in to a user account using the cash station 14. The system 10 may include more than one cash station 14, the one or more cash station(s) 14 being connected to the central server 12. The cash station 14 may receive funds from the user via any appropriate means of transferring or depositing funds, including, but not limited to including, physical cash input devices, credit/debit card readers, token input, etc.

Components of the system 10 may be connected by wired means, such as a local Ethernet connection and/or any other suitable hardwired data connections. Various components, such as the cash station 14 and/or the game station 11, may be media presentation devices such as kiosks, game consoles, etc. Additionally or alternatively, components of the system 10 may be connected via wireless means, such as a wide-area network (WAN), a local area network (LAN), a personal area network (PAN), a wi-fi network, and/or a connection via the Internet. The game station may be a portable media device, such as a smart phone, a tablet, a laptop computer, a game console, etc. Any combination of wireless and hardwired means mentioned above may be used in the system 10. Further, any combination of the above mentioned devices and/or methods of connectivity may be used.

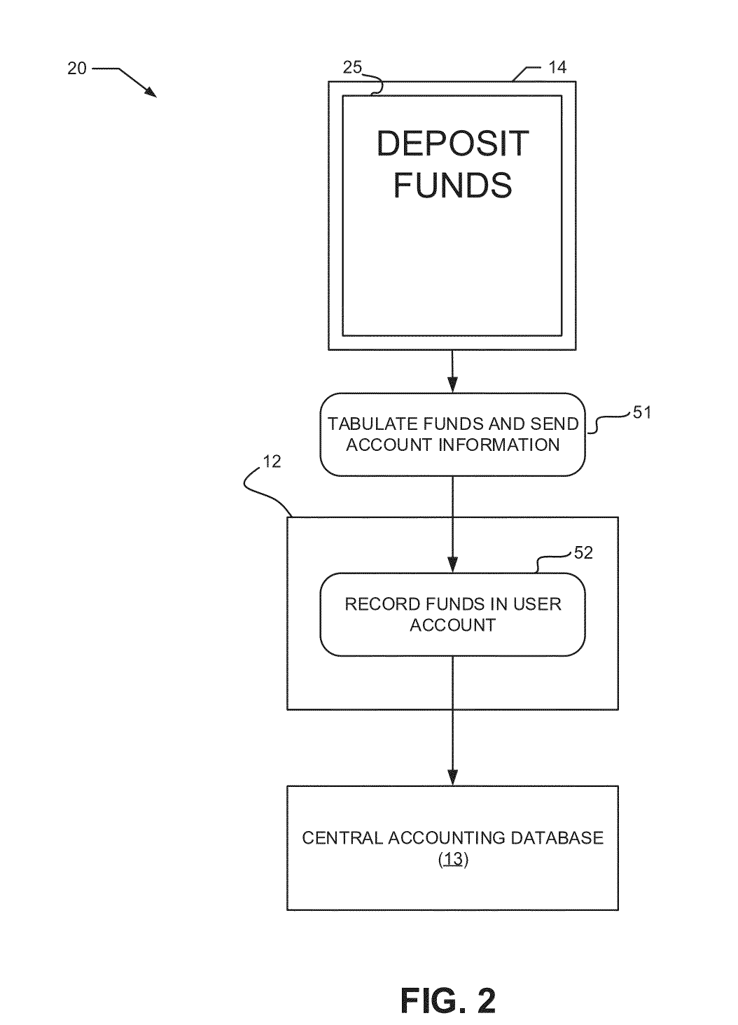

With continued reference to the components of FIG. 1, FIG. 2 shows a process 20 as executed by the system 10, wherein funds are deposited to the central accounting system 12 via the cash station 14. The cash station 14 may include a user interface 25 instructing the user to transfer or deposit funds in the cash machine 14. Once funds are deposited, the amount of funds is tabulated and reported to the central accounting server 12 (block 21). The central server 12 may record the deposited funds to a user account associated with the user (block 22). The user account information may be stored on the central accounting database 13. The user account may be associated with an account card which may be read by the cash station 14.

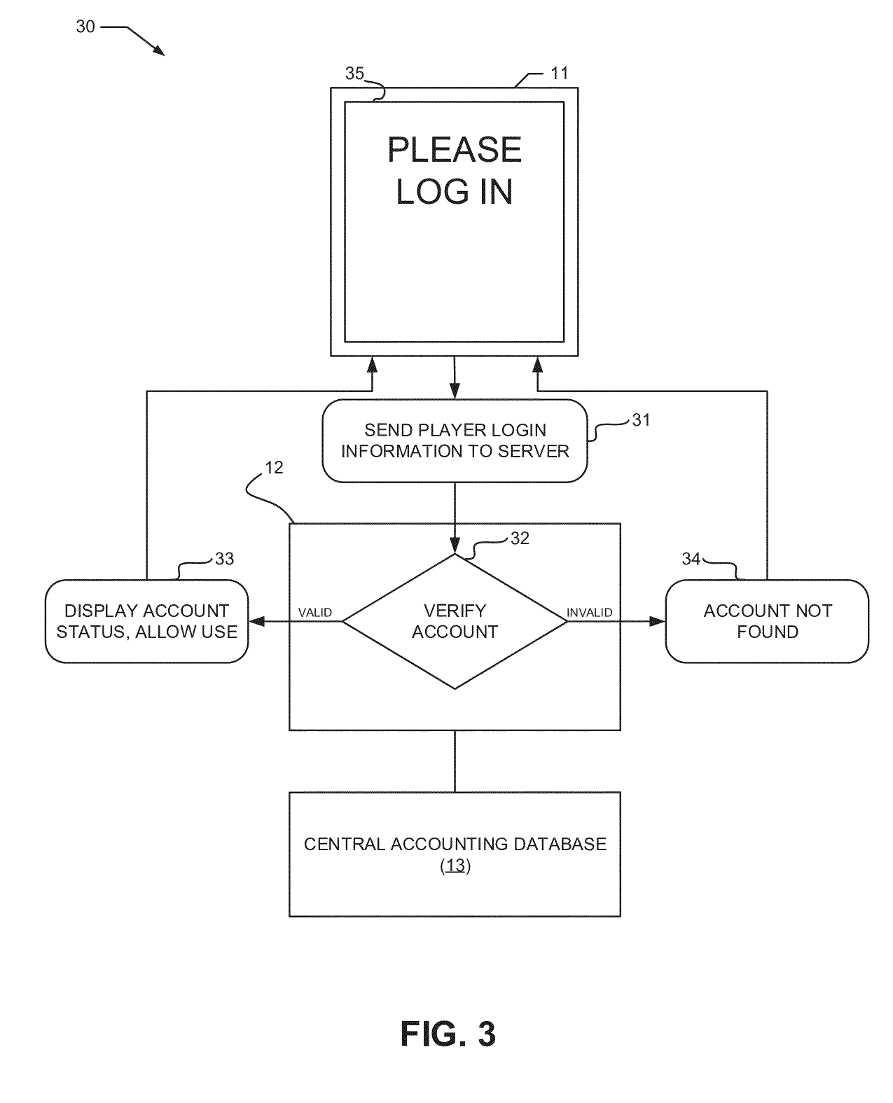

To access a nudge game, the user interacts with a game station 11. The game station 11 may perform a login process 30 (FIG. 3). The game station 11 displays a login prompt 35, wherein the user provides information associated with his/her user account to access the nudge game. The login process 30 may require a user name and/or a password. In some examples, the login process 30 may require a user to input information associated with an account card (e.g., by swiping the card through a card reader associated with the game station 11). In some such examples, the account card may require further verification, for example, verification by inputting a password or personal identification number (PIN).

Once the user has input his/her login information, the player login information is sent to the central server 12 (block 31). The central server 12 may verify the login information with account records, which may be stored on the central accounting database 13 (decision 32). If the user has input invalid login information, the central accounting server 12 will send a message to the game station 11 alerting the user that the account input is not found (block 34). When the user inputs valid account information, the central server 12 will allow the game station 11 to access a nudge game application of the central server 12 (block 33). The game station 11 may display the status of the account (e.g., the amount of funds available in the account).

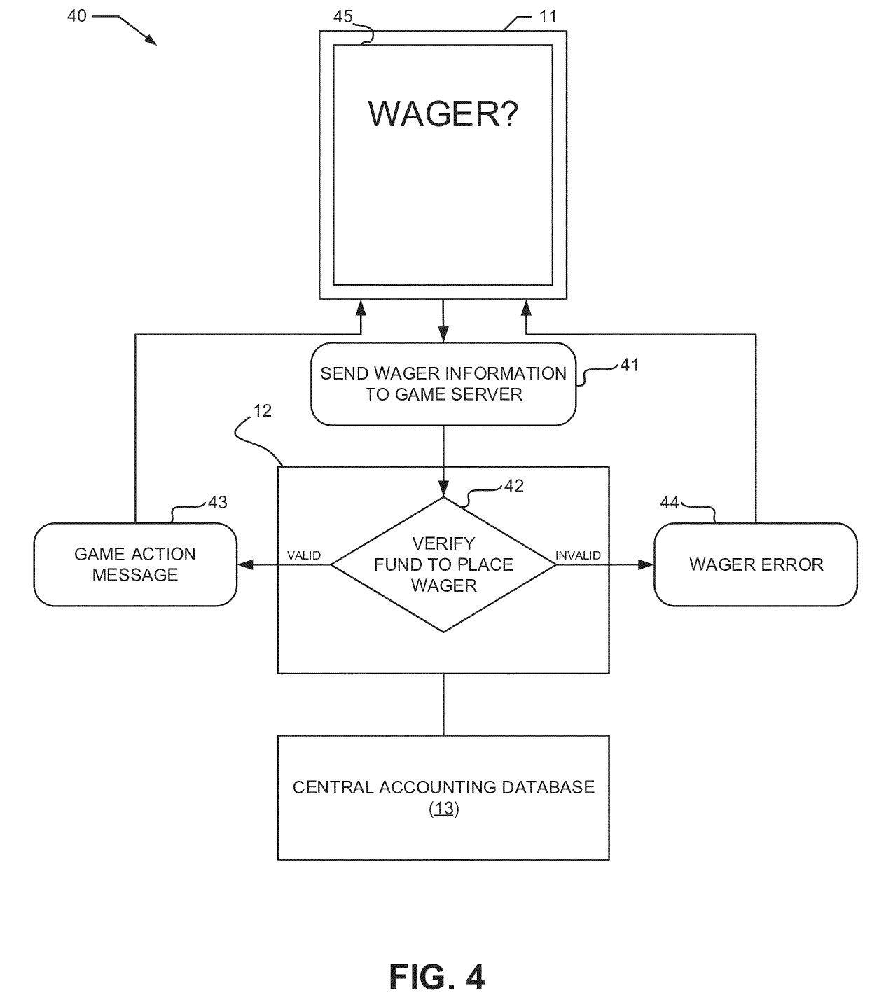

Prior to playing the nudge game, the user may enter a wager using funds in his/her user account. FIG. 4 shows a wager process 40 enacted by the system 10, wherein the user is prompted by the user interface 45 of the game station 11. The user enters his/her wager into the game station 11. The wager information is sent to the central server 12 (block 41) and the central server 12 determines if the user's account contains enough funds to place the input wager (decision 42). The wager may be any amount greater than or equal to the requisite amount of funds needed to begin a nudge game. If the wager information is invalid (e.g., insufficient funds in the user account), then a wager error message is transmitted to the game station 11 and may be displayed to the user via the game station 11 (block 44). If the wager information is valid (e.g., the user account has sufficient funds to place the wager), then a game action message is sent to the game station 11 (block 43). For example, the game action message may initiate the nudge game application of the central server 12.

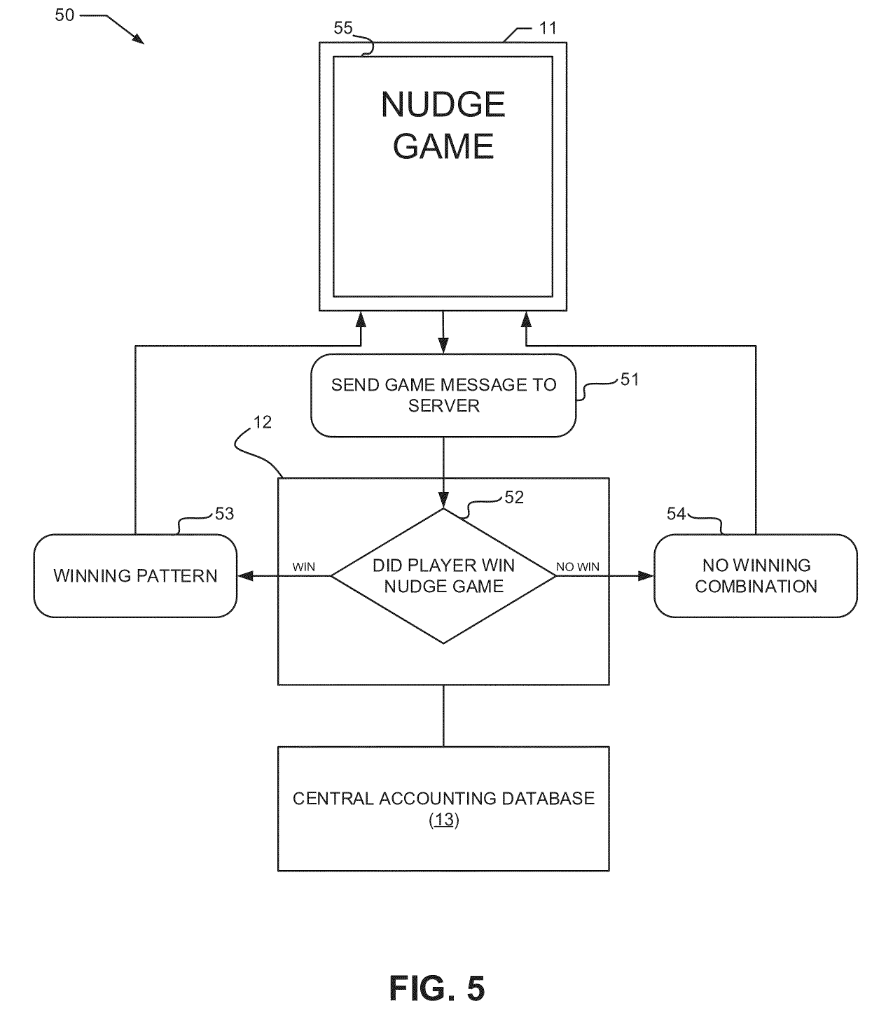

Referring now to FIGS. 5-7, a process 50 for presenting and executing the nudge game application 55 is shown. The nudge game application 55 may display a plurality of reels 57, the plurality of reels displaying a plurality of symbols 61, 62, 63, 64, 65, 66. Once the user starts the nudge game 55, the reels 57 may roll and then come to a stop (55A). When the user is presented with the completed roll of the reels 57, the user is presented with the option to nudge a rail up and/or down using a plurality of nudge up buttons 68 and/or the plurality of nudge down buttons 67, respectively. The nudge up buttons 67 and the nudge down buttons 68 may be physical buttons located on the game station 11, virtual buttons located on a touch-screen display, and/or any other means of signaling, to the nudge game application, intent to nudge a reel.

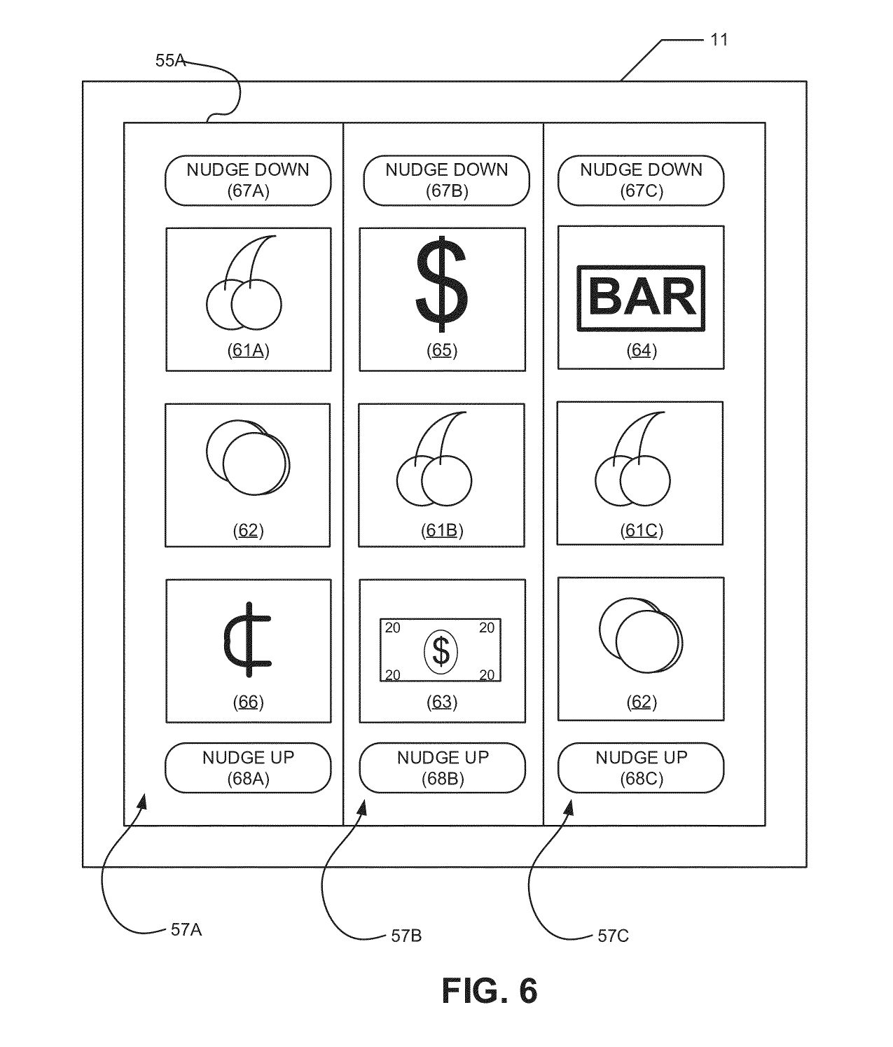

The example display state of the nudge game application 55A of FIG. 6 shows the nudge game application 55 at the end of an initial iteration wherein the reels have stopped. In the example nudge game, a horizontal row of three like symbols is a payline. When a payline is achieved, the nudge game is won. In the present example, the current display state 55A shows two symbols 61B, 61C horizontally aligned and a third symbol 61A one space above the two horizontally aligned symbols. With the rules of the present example, the user may nudge a reel 57 using the nudge up and down buttons 67, 68 to attempt to achieve a payline.

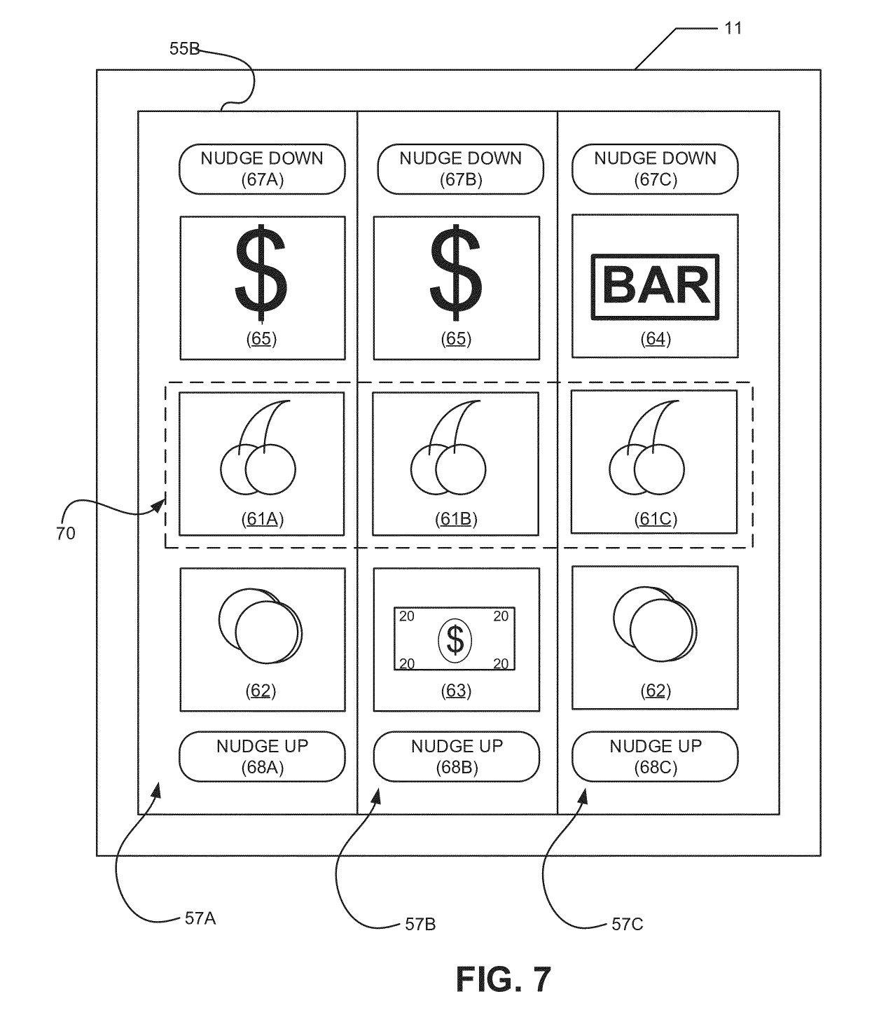

In an example display state of the nudge game application 55B of FIG. 7, the user has pressed the nudge down button 68A associated with the reel 57A. In doing so, the user has achieved the payline 70 of symbols 61A, 61B, 61C by nudging the symbol 61 down one place. Achieving the payline 70 may entitle the user to a prize in the form of a resultant amount of funds. However, the prize does not need to be funds it may also be any goods, services, free credits for the nudge games, a door prize, etc.

Returning to FIG. 5, the game station 11 will send a game message to the central server 12 based on the result of the nudge game 55 (block 51). Based on the results of the nudge game, the central server 12 will determine if the results are a “win” or not (decision 52). If there is no winning combination, a message is sent to the game station 11 to inform the user there is no win (block 54). If there is a winning combination, a message is sent to the game station 11 to inform the user of his/her win (block 53).

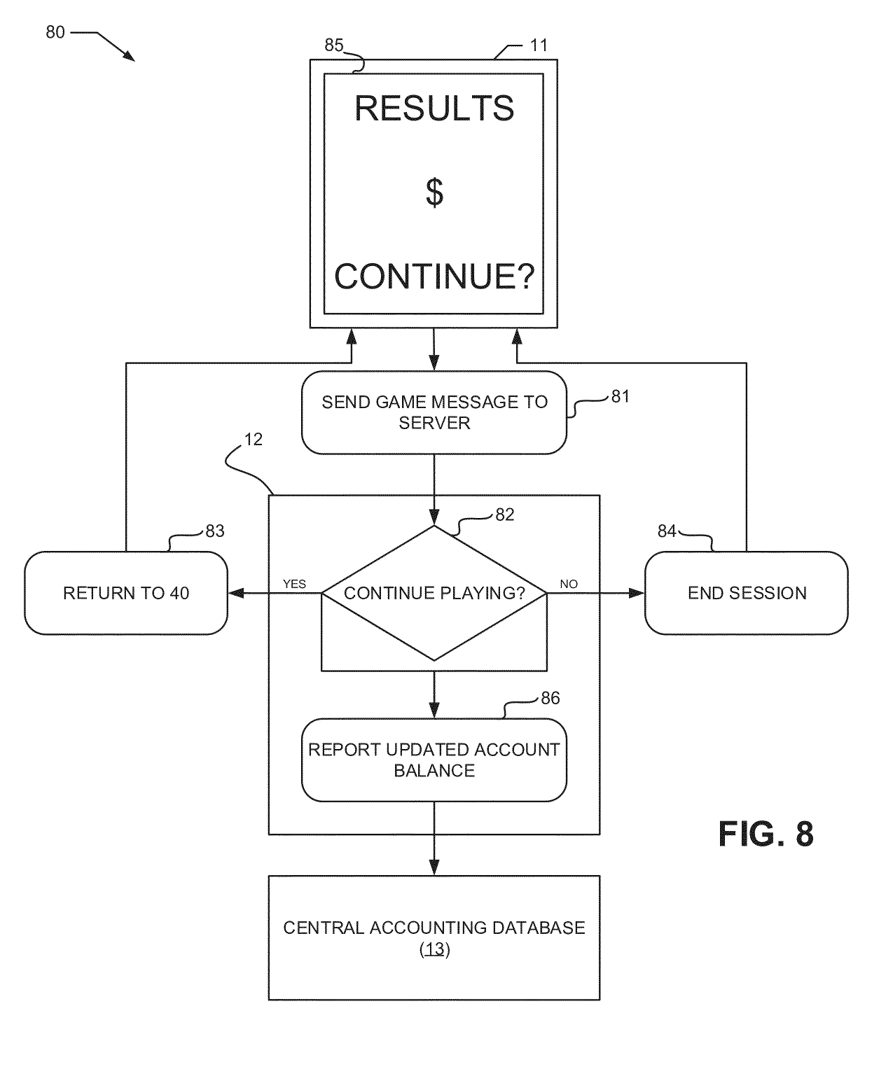

After an iteration of the nudge game, a user may be presented with the results and asked if he/she would like to continue playing the nudge game, as seen in the process 80 of FIG. 8. The game station 11 will send a message to the central server 12 asking the user if he/she would like to continue playing the nudge game (block 81). If the message says “yes,” the game server 11 may return to the process 40 of FIG. 4 and restart the nudge game (block 83). If the user's message indicates “no,” the nudge game session will end (block 84). The central server 12 may report an updated user account balance to the central accounting database 13 (block 86).

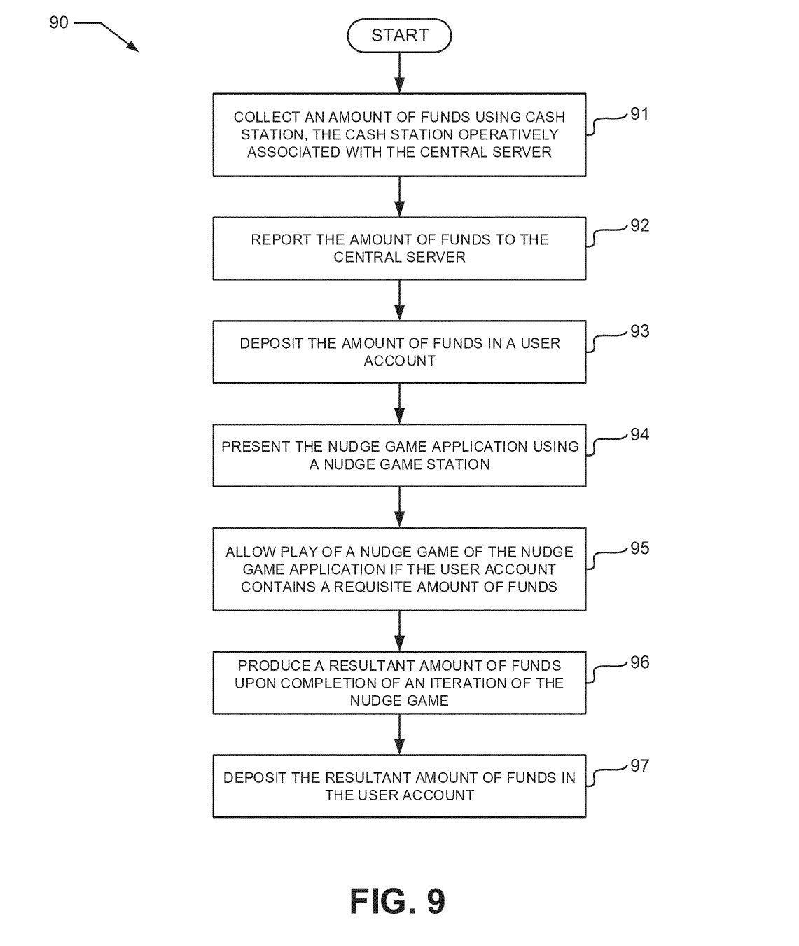

An example process 90 for providing a nudge game in accordance with the system 10 of FIG. 1 is exemplified in the flow chart of FIG. 9. At block 91, funds may be collected using the cash station 14, the cash station 14 being operatively associated with the central server 12. The amount of funds may be reported to the central server 12 (block 92). At block 93, the amount of funds is deposited in a user account. The game station 11 may present the nudge game application (block 94). At block 94, the central server 12 may allow play of a nudge game of the nudge game application if the user account contains a requisite amount of funds. Upon completion of an iteration of the nudge game, the central server 12 may produce a resultant amount of funds (block 96). The resultant amount of funds may be deposited in the user account (block 97).

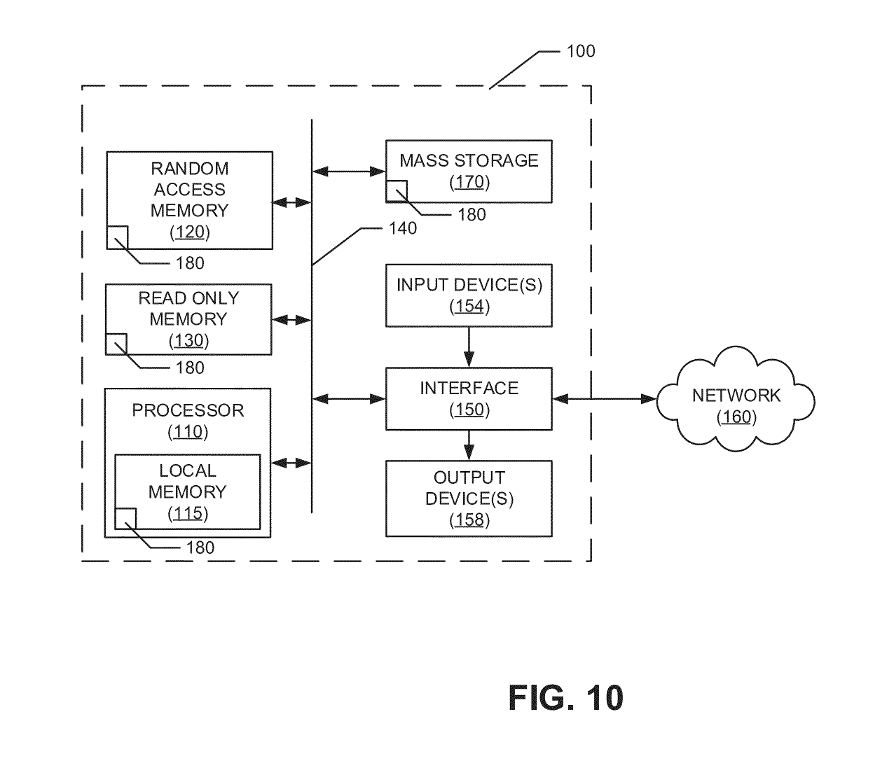

FIG. 10 is a block diagram of an example computing device 100 which may be used to implement the central server 12, the cash station 14, the game station 11 and/or the central accounting database 13. The computing device has a tangible machine readable medium capable of executing the instructions of FIGS. 2-5, 8, and 9 and/or to implementing any of the disclosed systems and methods. The computer 100 can be, for example, a server, a personal computer, or any other type of computing device. The system 100 of the instant example includes a processor 110. For example, the processor 110 can be implemented by one or more microprocessors or controllers from any desired family or manufacturer. The processor 110 includes a local memory 115 and is in communication with a main memory including a read only memory 130 and a random access memory 120 via a bus 140. The random access memory 120 may be implemented by Synchronous Dynamic Random Access Memory (SDRAM), Dynamic Random Access Memory (DRAM), RAMBUS Dynamic Random Access Memory (RDRM) and/or any other type of random access memory device. The read only memory 130 may be implemented by a hard drive, flash memory and/or any other desired type of memory device.

The computer 100 also includes an interface circuit 150. The interface circuit 150 may be implemented by any type of interface standard, such as an Ethernet interface, a universal serial bus (USB), and/or a PCI express interface. One or more input devices 154 may be connected to the interface circuit 150. The input device(s) 154 permit a user to enter data and commands into the processor 110. The input device(s) can be implemented by, for example, a keyboard, a mouse, a touchscreen, a track-pad, a trackball, isopoint and/or a voice recognition system. The interface 150 may operate in conjunction with, in parallel with, or in place of, any user interface.

One or more output devices 158 are also connected to the interface circuit 150 to display, for example, a cash machine display, a login screen, and/or the nudge game as shown in FIGS. 6 and 7. The output devices 158 can be implemented by, for example, display devices for associated data (e.g., a liquid crystal display, a cathode ray tube display (CRT), etc). The interface circuit 150 also includes may include a communication device such as a modem or network interface card to facilitate exchange of data with external computers via a network 160. The computer 100 also includes one or more mass storage devices 170 for storing software and data.

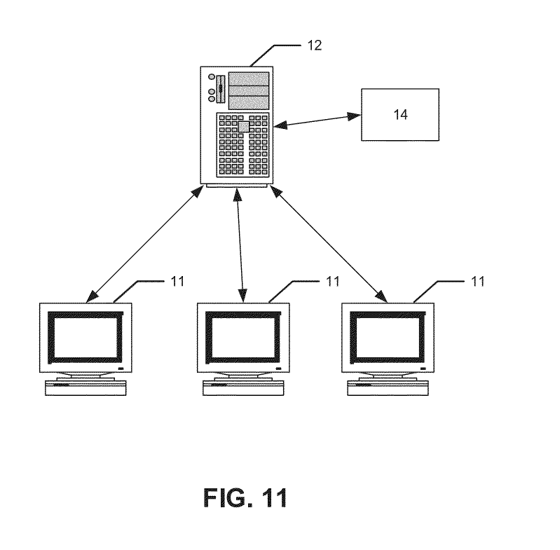

The nudge game can also be implemented in a network system design. FIG. 11 is a schematic network diagram showing network components and configurations in an embodiment of the nudge game system. This model, based off the components of FIG. 1, includes one location with a central server 12 used for processing the nudge game activity. Players add funds at a cash station 14 and play nudge games at the consoles 11. This process allows the players to add funds to the system for play on the nudge games consoles. In the system, the user may add additional funds with winnings accrued from the playing the nudge games.

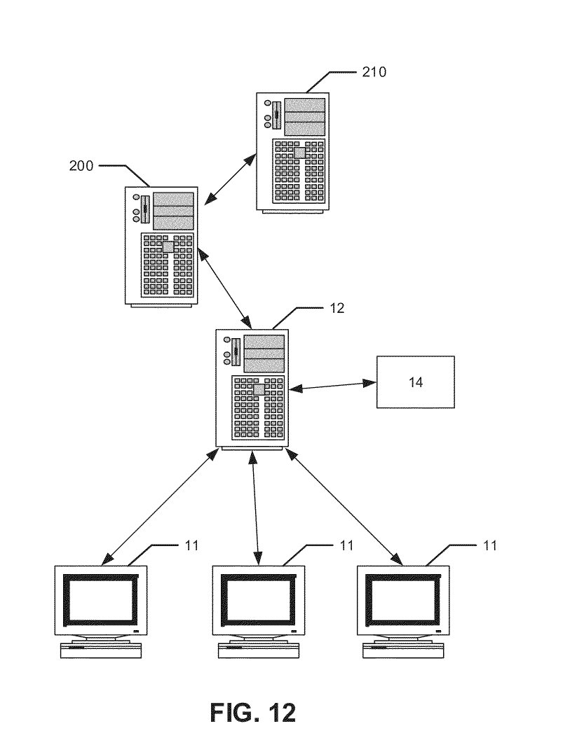

FIG. 12 is a schematic network diagram in an alternative embodiment of the nudge game system. The alternative model includes the features of the network of FIG. 11 but additionally includes a global accounting database 200 as well as a cash fund website server 210. In this model when a player adds funds to a user account, the global accounting database 200 is updated with the funds added to the user account. Further, in this model, the player may add funds to a user account on the console 11 or at a remote location or a website connected to the cash fund website server 210.

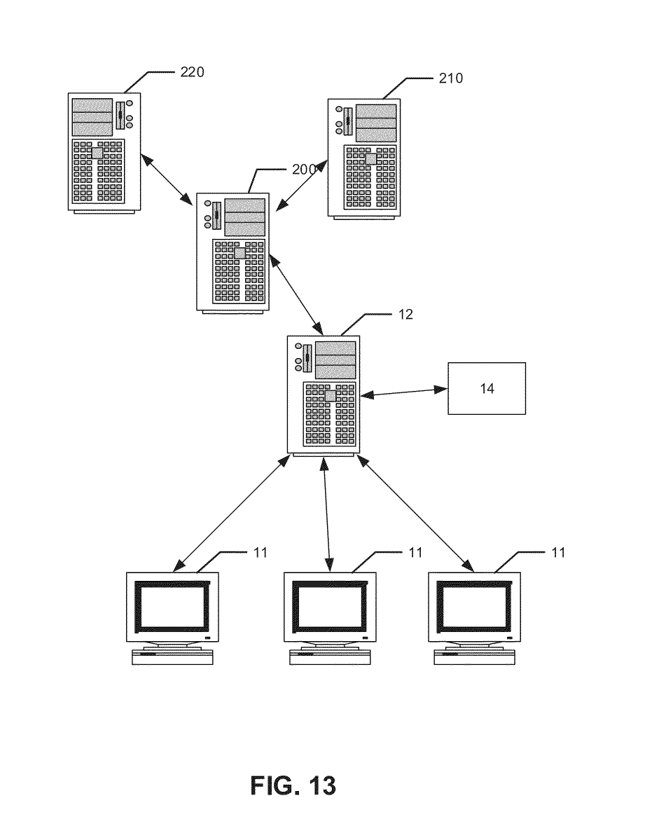

An additional model is shown in the network diagram of FIG. 13. In particular, in addition to the items shown in FIG. 12, the model of FIG. 13 includes a nudge game website server 220 to interface to the global accounting database 200. This model allows players to retrieve nudge game play statistics, gaming updates, funds available, and funds used on a user accessible website.

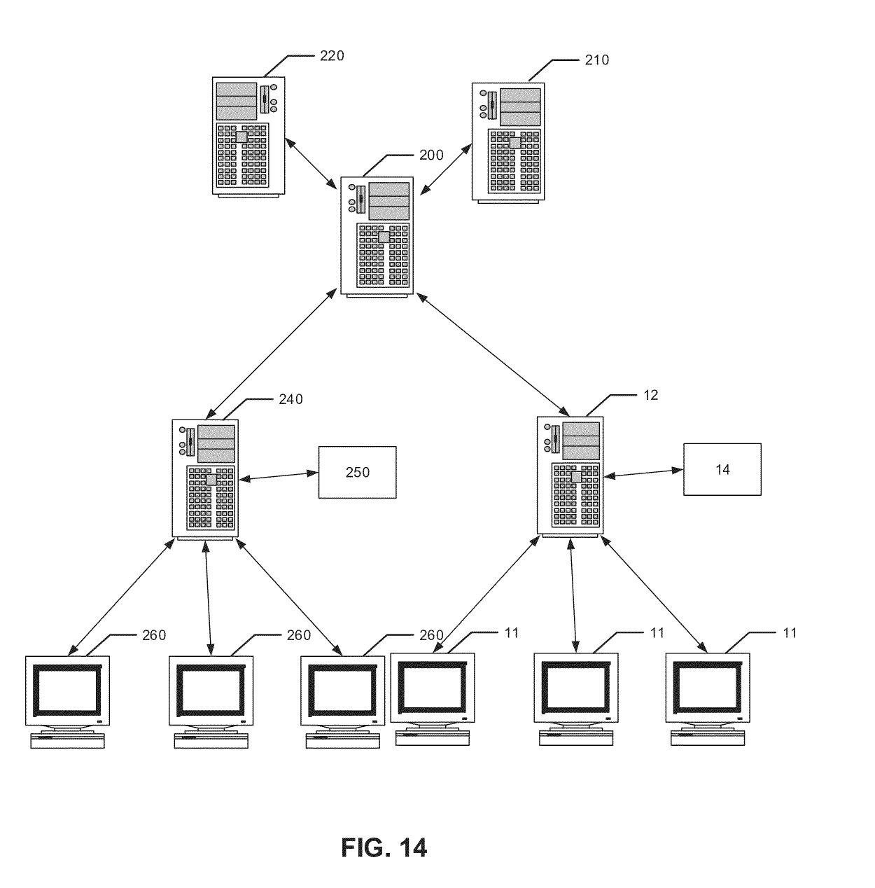

In another embodiment of the invention there are multiple locations connecting to the global accounting database 200, with a cash fund website server 210 and a nudge game website server 220 also connected to the global accounting database 200. This configuration is shown in FIG. 14. In particular, in addition to the elements shown in FIG. 13, the system also includes an additional cash station 250, local central server 240, and additional consoles 260 in communication with the global accounting database 200 so that users can play at multiple locations.

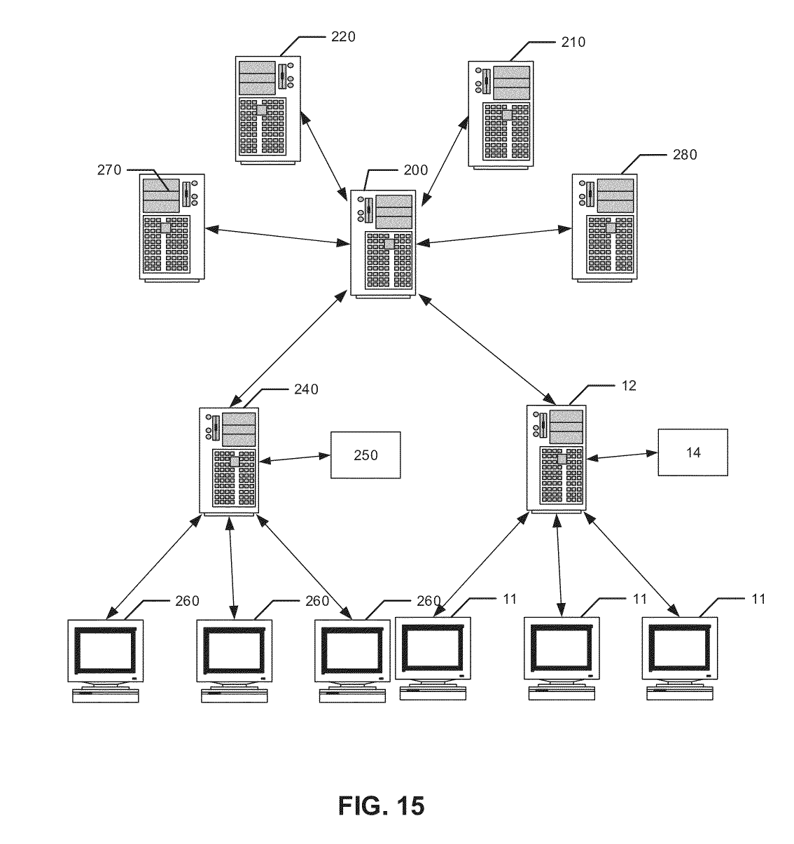

In another model there are multiple locations connecting to a global accounting database 200, with nudge gaming sites connecting to the global accounting database 200. This configuration is shown in FIG. 15. In the illustrated embodiment of the invention, in addition to the elements shown in FIG. 14, the system includes a penny auction system 270 and an additional sweepstakes system 270. Users accessing the cash fund website server 210 or the nudge game website server 220 can view game information or add funds to be used on a multitude of connected penny auction systems or sweepstakes systems as well as the nudge games connected to the network.

While only certain embodiments have been set forth herein, alternatives and modifications will be apparent from the above description to those of skill in the art. These and other alternatives are considered equivalents and within the spirit and scope of this disclosure and the appended claims.

What is claimed is:

1. A system for providing a nudge game, the system comprising:
a central server, the central server comprising:
a nudge game application; and
a central accounting system;
a cash station operatively associated with the central server to collect an amount of funds, wherein the cash station reports the amount of funds to the central accounting system and the central accounting system deposits the funds in a user account;
a nudge game station operatively associated with the central server to present the nudge game application;
wherein a nudge game of the nudge game application is available for play if the user account contains a requisite amount of funds; and
wherein the nudge game application produces a resultant amount of funds upon completion of an iteration of the nudge game, the resultant amount of funds being deposited in to the user account.

2. The system of claim 1, wherein the user account is associated with an account card to reference the user account.

3. The system of claim 1, further comprising a plurality of nudge game stations, each member of the plurality of nudge game stations operatively associated with the central server to present the nudge game application.

4. The system of claim 1, wherein the central server and the game station are connected by wired means.

5. The system of claim 1, wherein the central server and the game station are connected by wireless means.

6. The system of claim 1, wherein the nudge game station is a media presentation device at a fixed location.

7. The system of claim 1, wherein the nudge game station is a portable media presentation device.

8. A method for providing a nudge game, the method comprising:
collecting an amount of funds using a cash station, wherein the cash station is operatively associated with a central server, the central server comprising:
a nudge game application; and
a central accounting system;
reporting the amount of funds to the central accounting system;
depositing the amount of funds in a user account by the central accounting system;
presenting the nudge game application using a nudge game station;
allowing play of a nudge game of the nudge game application if the user account contains a requisite amount of funds;
producing a resultant amount of funds upon completion of an iteration of the nudge game; and
depositing the resultant amount of funds in the user account.

9. The method of claim 8, further comprising providing a login at the nudge game station.

10. The method of claim 8, further comprising providing access to a user account using an account card, the account card associated with the user account.

11. The method of claim 8, further comprising providing means to select a wager amount for the nudge game, wherein the wager amount is greater than or equal to the requisite amount of funds.

12. The method of claim 11, further comprising deducting the wager amount from the user account upon execution of the nudge game.

13. The method of claim 8, further comprising presenting an error message at the nudge game station if the user account does not contain the requisite amount of funds.

14. A nontransitory computer readable medium having thereon instructions for performing a method for providing a nudge game, the instructions comprising:
instructions for collecting an amount of funds using a cash station, wherein the cash station is operatively associated with a central server, the central server comprising:
a nudge game application; and
a central accounting system;
instructions for reporting the amount of funds to the central accounting system;
instructions for depositing the amount of funds in a user account by the central accounting system;
instructions for presenting the nudge game application using a nudge game station;
instructions for allowing play of a nudge game of the nudge game application if the user account contains a requisite amount of funds;
instructions for producing a resultant amount of funds upon completion of an iteration of the nudge game; and
instructions for depositing the resultant amount of funds in to the user account.

15. A nontransitory computer readable medium having thereon instructions for performing a method for providing a nudge game of claim 14, the method further comprising instructions for providing a login at the nudge game station.

16. A nontransitory computer readable medium having thereon instructions for performing a method for providing a nudge game of claim 14, the method further comprising instructions for providing access to a user account using an account card, the account card associated with the user account.

17. A nontransitory computer readable medium having thereon instructions for performing a method for providing a nudge game of claim 14, the method further comprising instructions for providing means to select a wager amount for the nudge game, wherein the wager amount is greater than or equal to the requisite amount of funds.

18. A nontransitory computer readable medium having thereon instructions for performing a method for providing a nudge game of claim 17, the method further comprising instructions for deducting the wager amount from the user account upon execution of the nudge game.

19. A nontransitory computer readable medium having thereon instructions for performing a method for providing a nudge game of claim 14, the method further comprising instructions for presenting an error message at the nudge game station if the user account does not contain the requisite amount of funds.
